(19) United States
(12) Patent Application Publication
(10) Pub. No.: US 2018/0281981 A1
(43) Pub. Date: Oct. 4, 2018

(54) METHOD FOR PROHIBITING THE PROPULSION OF AN ELECTRICAL AIRPLANE CONNECTED TO A GROUND STATION

(71) Applicant: Airbus SAS, Blagnac (FR)

(72) Inventors: Emmanuel JOUBERT, Issy-les-Moulineaux (FR); Phi Hung NGUYEN, Choisy Le Roi (FR); Amidou COULIBALY, Franconville La Garenne (FR); Laurent JUVE, Issy-les-Moulineaux (FR)

(21) Appl. No.: 15/935,565

(22) Filed: Mar. 26, 2018

(30) Foreign Application Priority Data
Apr. 3, 2017 (FR) 1752847

(51) Int. Cl. B64D 31/00; B60L 11/18

(52) U.S. Cl. CPC B64D 31/00; B60L 2200/10; B64D 2221/00; B60L 11/1851

(57) ABSTRACT

A method for prohibiting the propulsion of an electrical airplane when the airplane is galvanically connected to a ground station. The electrical airplane comprises a battery assembly, a low voltage electrical network provided with power contactors, at least one integrated electrical propulsion system and a processor. The method comprises steps of detection of a connection to the ground station by the battery assembly, of non-supply of the integrated electrical propulsion systems and of their switch to protection mode, and of stopping of the propulsion systems regardless of their supply of electrical energy and the user set point.

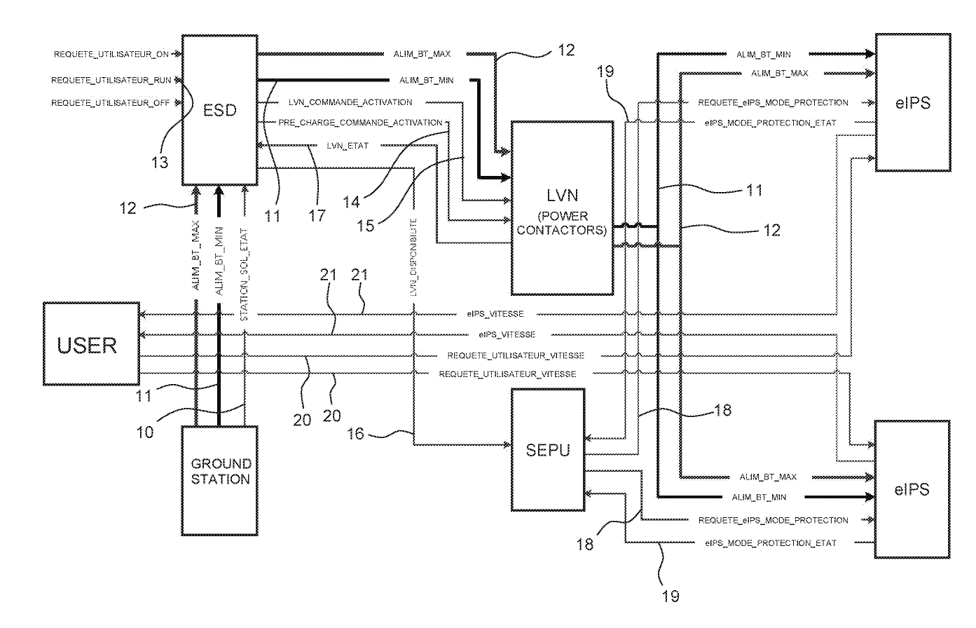

### CROSS-REFERENCES TO RELATED APPLICATIONS

This application claims the benefit of the French patent application No. 1752847 filed on Apr. 3, 2017, the entire disclosures of which are incorporated herein by way of reference.

### FIELD OF THE INVENTION

The present invention belongs to the field of the monitoring and control of the propulsive command of an aircraft, it relates more particularly to a method for prohibiting the propulsion of an electrical airplane when it is connected to a ground station for recharging its batteries.

### BACKGROUND OF THE INVENTION

The advent of electrical propulsion in certain civilian transport sectors, in particular the motor vehicle and aeronautic sectors, is accompanied by changing standards and safety regulations.

For battery-operated electrical land vehicles for example, the regulation number 100 of the United Nations Economic Commission for Europe (UNECE) comprises particular provisions applicable to operational safety. One aspect of this regulation stipulates that the vehicle must in no circumstances be able to move by itself when it is galvanically connected to a distribution network or to an external charger.

The electrical or hybrid airplanes still in the prototype stage are not subject to this regulation but it is best, in anticipation of the developments in electrical airplane propulsion, to anticipate the application of such standards in the aeronautical field.

### SUMMARY OF THE INVENTION

The present invention addresses this safety need and relates to a method for prohibiting the propulsion of an electrical airplane when it is galvanically connected to a ground station. The electrical airplane comprises a battery assembly, an electrical network provided with power contactors, at least one integrated electrical propulsion system and a processor, the method comprising, in order, the following steps:

detection of an electrical connection to the ground station by the battery assembly;

deactivation of the electrical network of the airplane by the battery assembly;

informing, by the electrical network of the battery assembly, of the deactivation of the power contactors;

informing, by the battery assembly of the processor, of the non-distribution of electrical energy to the at least one integrated electrical propulsion system;

request, from the processor, to the at least one integrated electrical propulsion system to switch to protection mode;

informing, by the at least one integrated electrical propulsion system, of the processor of the activation of the protection mode;

stopping of the at least one integrated propulsion system, regardless of its supply of electrical energy and regardless of the control lever set point of a user of the airplane, as long as the airplane is connected to the ground station.

Advantageously, the battery assembly comprises storage batteries and their monitoring and management system, the monitoring and management system prohibiting the activation of the pre-charging and the distribution of electrical energy to the at least one integrated electrical propulsion system in the step of deactivation of the electrical network by the battery assembly.

In one embodiment, the deactivation of the electrical network by the battery assembly is automated and occurs after the detection of a connection of the airplane to the ground station by the battery assembly.

In an alternative embodiment, the deactivation of the electrical network by the battery assembly is controlled by a user of the airplane.

In an advantageous embodiment of the invention, the electrical airplane comprises two integrated electrical propulsion systems.

In one embodiment, the electrical network is a low voltage electrical network operating at voltages lower than 1500 volts.

With the fundamental concepts of the invention having just been set out above in their most basic form, other details and features will emerge more clearly on reading the following description and in light of the attached drawings, giving by way of non-limiting example, an embodiment of a method in accordance with the principles of the invention.

### BRIEF DESCRIPTION OF THE DRAWINGS

The FIGURE represents a functional diagram of the elements of an airplane implementing the method according to the invention.

### DETAILED DESCRIPTION OF THE PREFERRED EMBODIMENTS

The acronyms which will be used hereinafter in the description are listed with their designations below:

ESD (Electronic Storage Device): battery assembly;

eIPS (electrical Integrated Propulsion System): integrated electrical propulsion system;

SEPU (Supervisor of Electrical Propulsion Unit): processor;

BMS (Battery Management system): battery monitoring and management system;

LVN (Low voltage Network): low voltage electrical network.

The FIGURE represents according to a preferred embodiment of the invention, a functional diagram of the interaction between the different elements involved in the implementation of the method for prohibiting the propulsion in an electrical airplane when it is connected to a ground station in order to recharge its batteries.

Typically, the method as described is intended to be implemented in an electrical airplane comprising an ESD, an electrical network provided with power contactors, eIPSs, an SEPU, which manages the interaction between these various elements.

The ESD comprises electrochemical storage batteries as well as a BMS allowing the state of the elements of the battery to be monitored, various energy and ergonomic-related quantities to be computed, the battery to be protected and its capacities to be optimized.

In a preferred embodiment, the electrical network is an LVN operating at voltages lower than 1500 volts for example, this value representing a threshold, commonly used in the electrotechnical industry. The LVN also comprises power contactors that make it possible to make or break the passage of the electrical current on the basis of a command.

Each eIPS comprises an electric motor coupled to propellers, or to any other propulsive mechanism ensuring the thrust necessary to the electrical airplane.

In the embodiment illustrated, the method is implemented in an electrical airplane comprising two eIPS as indicated in the FIGURE. The airplane is, nevertheless, still able to be controlled with a single eIPS and the implementation of the method is unaffected thereby.

The SEPU ensures a link between the eIPSs and the ESD.

The method, the subject of the present invention, makes it possible to prevent any possibility of generation of a thrust when the electrical airplane is electrically connected to a ground station, regardless of the set point of the throttle lever and regardless of the status of the propulsion unit, formed by the ESD, the electrical network and the eIPS s, which controls the pre-charging of the batteries and the distribution of energy to the eIPSs, the pre-charging comprising a charging of the capacitors of the batteries which serve as a buffer for limiting any high electrical current that might damage the eIPSs.

The method is based on a control-command strategy making it possible to inhibit the propulsion of the electrical airplane while the airplane is connected to a ground station according to the following three protection barriers:

prohibition of the pre-charging of the eIPSs;

prohibition of the supplying of the eIPSs with electrical energy;

forced switching of the eIPSs to protection mode.

Thus, when the electrical airplane is connected to a ground station, it has a robust protection both against an untimely supply of thrust, and against a deliberate supply of thrust by operation of the throttle lever and invocation of the RUN mode.

In a preferred embodiment, the control-command in the BMS and in the eIPS is ensured through discrete signals and 28 V DC power signals.

The 28 V DC signals are supplied by the ground station and the electrical network, and make it possible to actuate the power contactors of the electrical network.

The discrete signals, for their part, are used to detect the connection of the airplane to a ground station, to inform of the deactivation of the electrical network and to switch the eIPS to protection mode.

The method as described is based on a sequential model defined by a control algorithm and binary, or non-binary, variables described in the states of the various elements involved in the electrical airplane.

The different variables and/or set points directly involved in the execution of the method are described hereinbelow, their references in the FIGURE are recalled between parentheses:

STATION_SOL_ETAT (10): informs as to the presence or not of an electrical connection between the airplane and a ground station;

REQUETE_UTILISATEUR_RUN (13): status of the user set point for the RUN mode;

PRE_CHARGE_COMMANDE_ACTIVATION (14): status of the control of pre-charging of the batteries in the ESD;

LVN_COMMANDE_ACTIVATION (15): status of the control of low voltage energy distribution by the ESD;

LVN_ETAT (17): status of the power contactors in the low voltage network;

LVN_DISPONIBILITE (16): status of availability of the ESD to distribute low voltage energy;

REQUETE_eIPS_MODE_PROTECTION (18): status of the eIPS protection mode switching set point;

eIPS_MODE_PROTECTION_ETAT (19): status of the eIPS protection mode;

eIPS_VITESSE (21); eIPS speed in terms of motor rotation speed for example;

ALIM_BT_MIN (11): minimum eIPS low voltage energy supplies;

ALIM_BT_MAX (12): maximum eIPS low voltage energy supplies;

REQUETE_UTILISATEUR_VITESSE (20): set point of the throttle lever in motor power terms, for example.

In a preferred embodiment, the method for prohibiting the propulsion of an electrical airplane when it is galvanically connected to a ground station comprises, in order, the following steps numbered from 1 to 7:

1. The ESD detects the electrical connection to the ground station (STATION_SOL_ETAT=PRESENCE);
The battery is connected to the charging terminal by connecting the male and female connectors, which makes it possible to detect that the battery is connected to the charging terminal.

2. On a user RUN mode command (REQUETE_UTILISATEUR_RUN=ACTIVE), the ESD prohibits the activation of the pre-charging of the batteries and the distribution of low voltage energy to the eIPS (PRE_CHARGE_COMMANDE_ACTIVATION=LVN_COMMANDE_ACTIVATION=DESACTIVE);
the ESD prohibits the low voltage supply of the motors.

3. The LVN informs the ESD of the status of the power contactors (LVN_ETAT=DESACTIVE);
the ESD receives the information on the status of the contactors (open or closed).

4. The ESD informs the SEPU of the non-distribution of the low voltage energy to the eIPS (LVN_DISPONIBILITE=DESACTIVE);
the ESD returns this information to the SEPU.

5. The SEPU asks the eIPS to switch to protection mode (REQUETE_eIPS_MODE_PROTECTION=ACTIVE);
the SEPU returns the protection activated-information to the eIPS.

6. The eIPS inform the SEPU of the activation of their protection (eIPS_MODE_PROTECTION_ETAT=ACTIVE);
the eIPSs return the information to the SEPU.

7. The eIPSs do not apply the speed (eIPS_VITESSE=0), regardless of their supply of low voltage energy (ALIM_BT_MIN=ALIM_BT_MAX !=0) and regardless of the throttle lever set point (REQUETE_UTILISATEUR_VITESSE !=0).
the eIPSs cannot be started up during the battery charging phase.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for prohibiting the propulsion of an electrical airplane when it is galvanically connected to a ground station, said electrical airplane comprising a battery assembly, an electrical network provided with power contactors, at least one integrated electrical propulsion system and a processor, said method comprising, in order, the following steps:
detecting an electrical connection to the ground station by the battery assembly;
deactivating the electrical network of the airplane by the battery assembly;
informing, by the electrical network of the battery assembly, of the deactivation of the power contactors;
informing, by the battery assembly of the processor, of the non-distribution of electrical energy to the at least one integrated electrical propulsion system;
requesting, from the processor, to the at least one integrated electrical propulsion system to switch to protection mode;
informing, by the at least one integrated electrical propulsion system, of the processor of the activation of the protection mode;
stopping of the at least one integrated propulsion system, regardless of its supply of electrical energy and regardless of the control lever set point of a user of said airplane, as long as the airplane is connected to the ground station.

2. The method according to claim 1, in which the battery assembly comprises storage batteries and their monitoring and management system, said monitoring and management system prohibiting the activation of the pre-charging and the distribution of electrical energy to the at least one integrated electrical propulsion system in the step of deactivation of the electrical network by the battery assembly.

3. The method according to claim 1, in which the deactivation of the electrical network by the battery assembly is automated and occurs after the detection of a connection of the airplane to a ground station by said battery assembly.

4. The method according to claim 1, wherein the deactivation of the electrical network by the battery assembly is controlled by a user of the airplane.

5. The method according to claim 1, wherein the electrical airplane comprises two integrated electrical propulsion systems.

6. The method according to claim 1, wherein the electrical network is a low voltage electrical network operating at voltages lower than 1500 volts.
